(19) United States
(12) Patent Application Publication
(10) Pub. No.: US 2021/0182840 A1
(43) Pub. Date: Jun. 17, 2021

(54) TOKEN PROCESSING TO FACILITATE STORAGE OF TRANSACTION DATA IN A BLOCKCHAIN

(71) Applicant: PayPal, Inc., San Jose, CA (US)

(72) Inventors: Suryatej Gundavelli, San Jose, CA (US); Michael Todasco, Santa Clara, CA (US); Lorenz Breu, Palo Alto, CA (US)

(21) Appl. No.: 16/717,405

(22) Filed: Dec. 17, 2019

(51) Int. Cl. G06Q 20/36; H04L 9/06; G06Q 20/06

(52) U.S. Cl. CPC G06Q 20/3674; G06Q 20/0658; H04L 9/0643; H04L 9/0637

(57) ABSTRACT

A system includes a memory and a processor configured to execute computer instructions stored in the memory that when executed cause the system to perform operations. The computer instructions include a blockchain storage component to create a subsequent data block N+1 of a blockchain having N data blocks in response to a storage command, N being a positive integer. An activity token represents at least one previous network action of an entity operating the blockchain storage component. A blockchain processing component generates the storage command based on cryptographic processing of at least one of the N data blocks of the blockchain, the N+1 data block, and the activity token. The activity token is employed by the blockchain processing component to reduce the cryptographic processing of the N+1 data block.

### TECHNICAL FIELD

This disclosure relates generally to transaction systems, and more specifically, utilizing activity tokens to mitigate processing with respect to storage of transaction data in a blockchain.

### BACKGROUND

A blockchain is an implementation of a digital ledger. Similar to a database, a digital ledger can record information of various types, but unlike most databases, blockchain implementations employ cryptography to facilitate that recorded information is immutable and trusted. Data on the blockchain is immutable because it cannot be changed or removed, and it can thus be trusted because it is immutable. A given blockchain achieves this immutable quality by sharing instances of the ledger among different parties on a network and using a consensus model that employs multiparty agreement and verification each time an addition is made to the blockchain. Current consensus models however require large amounts of computing resources in order to establish trust in the blockchain. It would be desirable if more efficient systems methods were provided to determine consensus and/or store information on the blockchain.

### BRIEF DESCRIPTION OF THE DRAWINGS

Numerous example aspects, implementations, objects and advantages described herein will be apparent upon consideration of the following detailed description, taken in conjunction with the accompanying drawings, in which like reference characters refer to like parts throughout.

FIG. 1 illustrates a block diagram of an example, non-limiting network system that includes a blockchain storage component to facilitate storing transaction data in a blockchain in accordance with one or more examples described herein.

FIG. 2 illustrates a block diagram of an example, non-limiting network system that includes at least one validator component and blockchain responder component to facilitate storing transaction data in a blockchain in accordance with one or more examples described herein.

FIG. 3 illustrates a block diagram of an example, non-limiting network system that includes a transaction component operated by at least one validator component to facilitate validating and storing transaction data in a blockchain in accordance with one or more examples described herein.

FIG. 4 illustrates a block diagram of an example, non-limiting network system that includes a blockchain storage component operating in accordance with a token generator to generate an activity token to facilitate storing transaction data in a blockchain in accordance with one or more examples described herein.

FIG. 5 illustrates a block diagram of an example, of an activity monitor component to monitor blockchain activities and to apply weighting parameters to the activities to facilitate storing transaction data in a blockchain in accordance with one or more examples described herein.

FIG. 6 illustrates a block diagram of an example, a token generator component that receives weighting parameters to generate an activity token to facilitate storing transaction data in a blockchain in accordance with one or more examples described herein.

FIG. 7 illustrates a block diagram of an example, non-limiting method executed by a system and processor that employs an activity token to facilitate storing transaction data in a blockchain in accordance with one or more examples described herein.

FIG. 8 illustrates a block diagram of an example, non-limiting method executed by a system and processor that employs an activity token to mitigate hash processing of a data block to facilitate storing transaction data in a blockchain in accordance with one or more examples described herein.

FIG. 9 illustrates a block diagram of an example, non-limiting network system that includes a blockchain storage component and a blockchain processing component to facilitate storing transaction data in a blockchain in accordance with one or more examples described herein.

FIG. 10 illustrates a block diagram of an example, non-limiting machine-readable medium that includes a blockchain storage component, a blockchain processing component, and a token generator component to facilitate storing transaction data in a blockchain in accordance with one or more examples described herein.

FIG. 11 is a schematic block diagram illustrating a suitable operating environment example to facilitate storing transaction data in a blockchain in accordance with one or more examples described herein.

FIG. 12 is a schematic block diagram of an example-computing environment to facilitate storing transaction data in a blockchain in accordance with one or more examples described herein.

### DETAILED DESCRIPTION

Systems and methods are provided for generating and utilizing activity tokens to mitigate processing and facilitate storage of transaction data in a blockchain. in a secure and efficient manner One or more validator components operate with transaction components (e.g., transaction interface) to facilitate transactions between a transactor (or transactors) and another system (or systems). Records of the transactions can be stored in the blockchain by a blockchain storage component operating with the validator components and/or operating via a separate entity such as a blockchain responder component. The blockchain storage component creates a subsequent data block of a blockchain in response to a storage command, where the activity token is employed to reduce processing associated with the creation of subsequent data blocks in the blockchain.

The activity token represents a previous network action (or actions) of an entity (e.g., validator component and/or blockchain responder component) operating the blockchain storage component. A blockchain processing component operating with the blockchain storage component generates the storage command based on cryptographic processing of at least one of the data blocks of the blockchain, the subsequent data block, and/or the activity token. The activity token is employed by the blockchain processing component to reduce the cryptographic processing of the subsequent data block. The activity token enables the blockchain processing component to select a reduced set of hash data from the subsequent data block in the cryptographic processing of the subsequent data block. In an example, the activity token reduces blockchain processing by enabling the blockchain processing component to solve either the original cryptographic hash function or a cryptographic hash function that begins with at least one binary digit not including the original stopping criteria from a previous hash function applied to the subsequent data block. The activity token can be expressed as a numerical value, a mathematical function, or a probability value that indicates reliability of the blockchain storage component to create the subsequent data block in the blockchain based on previous network activities.

An activity monitor component records activity data relating to the network activities of the blockchain storage component and can assign a weighting parameter to the activity data associated with each of the respective network activities. For instance, the activity data can include at least one of prior blockchain storage activity data for the blockchain storage component, a rate of transaction data for the blockchain storage component, and/or associations activity data relating to prior interactions of the blockchain storage component and other network components. The rate of transaction data can be related to quantity of interactions the blockchain storage component has with other network components, types of interactions the blockchain storage component has with other network components, time of interactions the blockchain storage component has with other network components, and/or influence of the blockchain storage component has with respect to other network components. A token generator operating with the activity monitor processes the weighting parameters and generates a weighting score that assigns a relative value to the weighting parameters, where the weighting score can be compared to a threshold value to determine whether to issue the activity token to the blockchain storage component.

The transactions described herein to generate the transaction data to be stored in the blockchain, for example, may be related to financial transactions between a transactor (e.g., user requesting a transaction) and a retailer, a user and a bank, a user attempting to load a file (e.g., music or literature), or some other type of transaction. The validator components and transaction components can be configured as a transaction system to facilitate such transactions between the transactors and the respective entities in which underlying transaction data is to be exchanged. The validator components may request different types of information in the form of a query from the transactors in order to authenticate and/or further validate a given transaction (e.g., validate an authenticated person is involved in the exchange versus a computer program acting as the person).

By utilizing activity tokens to facilitate storage of transaction data in the blockchain, less overall processing is involved to both facilitate security and establish future trust in the blockchain. Thus, blockchain validation and/or consensus can be achieved in a secure and more efficient manner than current systems that require vast amounts of computing resources such as currently employed for cryptographic hash processing of entire data blocks. Moreover, trust can be achieved via the processing of activity tokens described herein that allows updating and/or adding new data blocks while mitigating vast arrays of computing resources and processing to establish trust in the blockchain.

In an example, a system includes a memory and a processor configured to execute computer instructions stored in the memory that when executed cause the system to perform operations. The computer instructions include a blockchain storage component to create a subsequent data block N+1 of a blockchain having N data blocks in response to a storage command, N being a positive integer. An activity token represents at least one previous network action of an entity operating the blockchain storage component. A blockchain processing component generates the storage command based on cryptographic processing of at least one of the N data blocks of the blockchain, the N+1 data block, and the activity token. The activity token is employed by the blockchain processing component to reduce the cryptographic processing of the N+1 data block.

In another example, a computer-implemented method includes receiving, by a system having a processor and a memory, an activity token that is derived from at least one previous network action of an entity operating in accordance with a blockchain, the blockchain having N data blocks, N being a positive integer. The method includes selecting, by the system, a reduced set of hash data from the Nth data block in the cryptographic processing of a subsequent data block N+1 based on the activity token. The method includes generating, by the system, a storage command to update transaction data in the N+1 data block based on cryptographic processing of at least one of the N data blocks of the blockchain, the N+1 data block, and the reduced set of hash data from the Nth data block. The method includes creating, by the system, the subsequent data block of the blockchain in response to the storage command.

In yet another example, a non-transitory machine-readable medium having machine-readable instructions that when executed by a processor cause the processor to generate an activity token that is derived from at least one previous network action of an entity operating in accordance with a blockchain, the blockchain having N data blocks, N being a positive integer. The instructions select a reduced set of hash data from the Nth data block in the cryptographic processing of a subsequent data block N+1 based on the activity token. The instructions generate a storage command to update transaction data in the N+1 data block based on cryptographic processing of at least one of the N data blocks of the blockchain, the N+1 data block, and the reduced set of hash data from the Nth data block. The instructions store the transaction data in the subsequent data block of the blockchain in response to the storage command.

Various aspects of this disclosure are now described with reference to the drawings, wherein like reference numerals are used to refer to like elements throughout. In the following description, for purposes of explanation, numerous specific details are set forth in order to provide a thorough understanding of one or more aspects. It should be understood, however, that certain aspects of this disclosure may be practiced without one or more of these specific details in various examples, or with other methods, components, materials, and so forth. not explicitly mentioned herein. In other instances, well-known structures and devices are shown in block diagram form to facilitate describing one or more aspects disclosed herein.

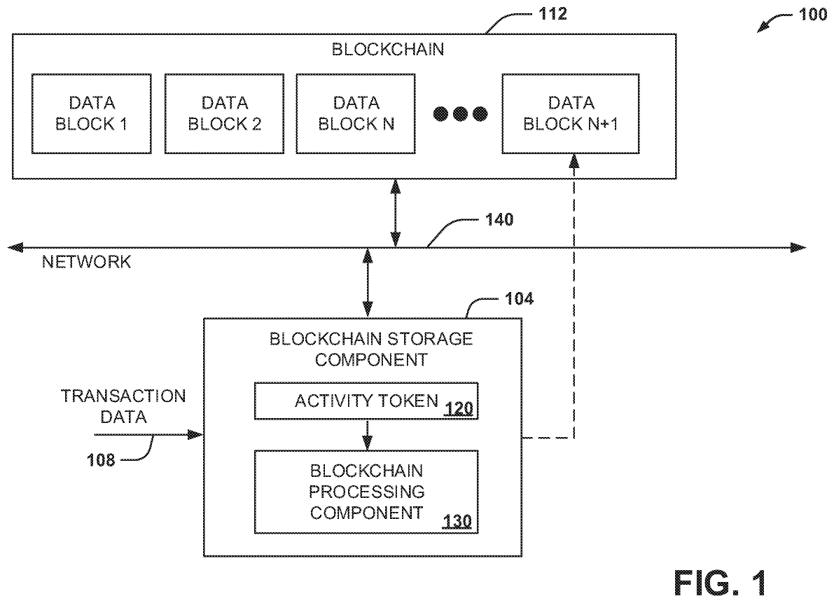

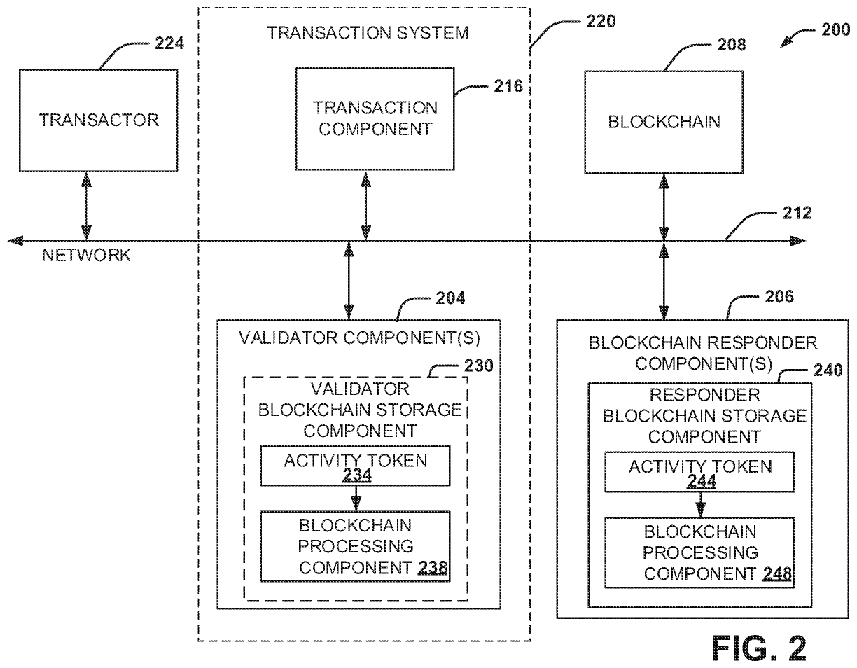

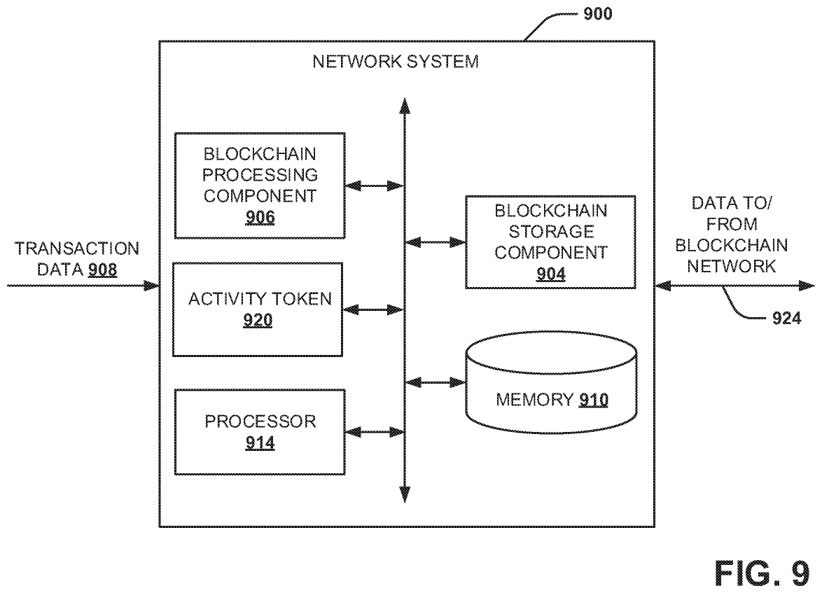

FIG. 1 illustrates an example of a non-limiting network system 100 that includes a blockchain storage component to facilitate storing transaction data 108 in a blockchain 112 in accordance with one or more examples described herein. The system 100 includes a memory and a processor (not shown) (see e.g., FIG. 9) configured to execute computer instructions stored in the memory that when executed cause the system to perform operations as described herein. The computer instructions include the blockchain storage component 104 to create a subsequent data block N+1 of the blockchain 112 having N data blocks in response to a storage command, N being a positive integer. An activity token 120 represents at least one previous network action of an entity (see e.g., FIG. 2 validator component and/or blockchain responder component) operating the blockchain storage component 104. A blockchain processing component 130 generates the storage command based on cryptographic processing of at least one of the N data blocks of the blockchain 112, the N+1 data block, and the activity token 120. The activity token 120 is employed by the blockchain processing component 104 to reduce the cryptographic processing of the N+1 data block of the blockchain 112. As shown, the blockchain storage component 104 operates over a network 140 to interact with the blockchain 112 and store the transaction data 108 therein.

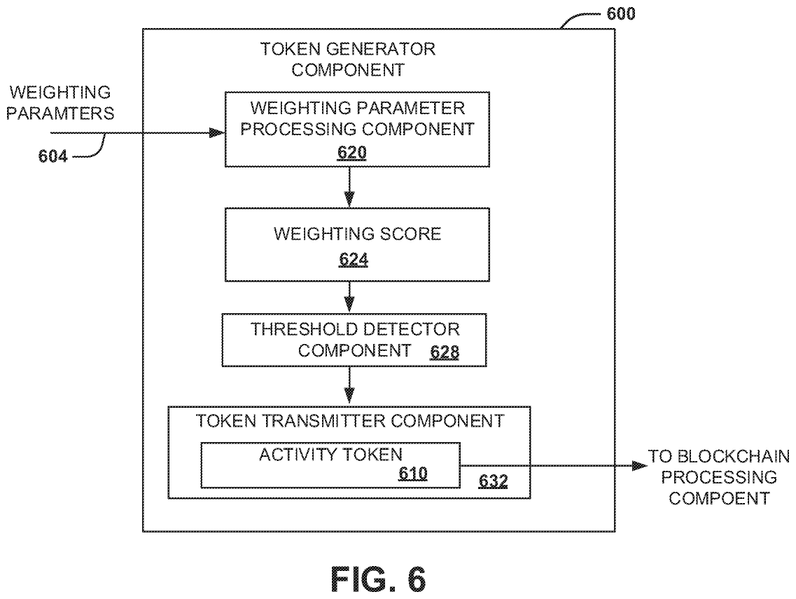

The activity token 120 enables the blockchain processing component 120 to select a reduced set of hash data from the Nth data block in the cryptographic processing of the N+1 data block. In an example, the activity token 120 enables the blockchain processing component 130 to solve a cryptographic hash function represented as H(H(N+1), Nonce) that removes at least one binary digit from a previous hash function applied to the Nth data block of the blockchain 112, where H is a hash operation, H(N+1) is a hash function applied to the N+1 data block of the blockchain, and the Nonce is an arbitrary number that is used singularly (e.g., pseudo-random number applied one time) in a cryptographic process. The activity token 120 can be expressed as a numerical value, a mathematical function, or a probability value that indicates reliability of the blockchain storage component 104 to create the subsequent data block (e.g., N+1 data block) in the blockchain 112 based on previous network activities which are described below with respect to FIG. 6.

Rather than current systems that utilize vast amounts of computing resources to solve cryptographic hash algorithms that operate over the entire history of the blockchain 112, the blockchain storage component 104 encrypts the transaction data 108 as part of a storage operation to the blockchain based on history determined from its respective prior network activities as represented by the activity token 120. In this manner, a reduced portion of cryptographic data associated with processing of the transaction data 108 is used to determine trust in the blockchain and thus much fewer computing resources and processing is involved to both establish the trust and to facilitate immutability in the blockchain. Thus, stored data in the blockchain 112 cannot be changed and is immutable without entities (such as the entities shown in FIG. 2) being aware of such changes since such entities are responsible for the security mechanisms that enabled respective updates to the blockchain.

FIG. 2 illustrates an example of a non-limiting network system 200 that includes at least one validator component 204 and/or blockchain responder component 206 to facilitate validating and storing transaction data in a blockchain 208 in accordance with one or more examples described herein. As mentioned previously, the blockchain 208 can be configured as a series of data blocks where new data blocks are added to the blockchain based on the security protocols and activity tokens described herein. The blockchain 208 can be accessed over a public and/or private network 212 (e.g., Internet, Intranet, business network) and managed by one or more entities entrusted to update the blockchain. The validator component 204 (or components) operates with a transaction component 216 and forms a transaction system 220 to facilitate receiving transaction data from a transactor 224 operating over the network 212. In an example, the transaction system 220 can manage and/or process transactions associated with electronic accounts of users (e.g., facilitate payment between transactor and a third party, transfer files between parties, initiate secure activities between parties, and so forth). The transaction component 216 can operate as an online transaction interface (or cellphone application), for example, to facilitate receiving the transaction data from the respective transactor 224.

As used herein, a transactor is a user who creates a given transaction to generate the transaction data described herein by interacting with the transaction component 216. The transaction data can include financial transactions, intellectual property transactions such as music or literature, barter transactions, auction transactions, and substantially any type of suitable transaction where transaction data is exchanged between the transaction component 216 and the transactor 224 to facilitate the transaction. The validator component 204 as used herein, is operated as a third-party component to facilitate a given transaction between the transactor 224 and some other party (e.g., a bank, a retailer, an auction service, a credit card company). The validator component 204 provides validation and authentication for a given transaction. As used herein, the term blockchain responder component 206 refers to an entity entrusted to update the blockchain 208 separately and/or in addition to the validator component 204 based on suitably solving cryptographic hash functions and/or in response to commands from the validator component 204.

As used herein, the term validation refers to the process of the validator component 204 (or components) determining if blockchain responder components 206 are credentialed and have solved enough security protocols (e.g., cryptographic processing of one or more data blocks of the blockchain) to update the blockchain 208 with the transaction data described herein. As used herein, authentication is the process where a given transaction system 220 operating the validator component 204 and transaction component 216 initially checks a user's credentials (e.g., via a transaction interface) and determines whether to proceed with a given transaction before the validation begins. Thus, authentication generally occurs before validation although such processes can occur concurrently. After suitable authentication and validation, the validator component(s) 204 can authorize blockchain responders 206 (or take action themselves) to transfer transaction data (or other data) to the respective blockchain 208.

As part of authentication, the validator component 204 can generate a query (or queries) to the transactor 224 via the transaction component 216 that is encrypted. The query can contain some portion of the underlying transaction with the transactor 224. For instance, the portion of transaction data can include a portion of the transaction itself (e.g., what is the second item in the transaction, how much is the third item in the transaction), timestamp information regarding the timing of the transaction, contextual information regarding some aspect of the transaction such as what building is nearby, what street is the transaction taking place, what is the current temperature, and so forth. Another type of authentication protocol that may be employed by the transaction system 220 is a Turing test such as for example, a Completely Automated Public Turing test to tell Computers and Humans Apart (CAPTCHA) that is a type of challenge-response test used in computing to determine whether the transactor 224 is human.

Upon suitable cryptographic processing, the validator components 204 can notify the blockchain responder component 206 to update the blockchain 208 with the transaction data associated with respective transactions gathered in accordance with their associated transactors 224. In yet other examples, upon verification, the validator component 204 may update the blockchain 208 with the transaction data and thus bypass the update by the blockchain responder component 206. The blockchain responder component 206 can be any suitable entity having authority to update the blockchain 208 upon successfully completing the security protocols described herein. In a crypto-currency example, the blockchain responder component 206 could be a “minor” that performs cryptographic processing of the transaction data, however, the systems and methods described herein are not limited to blockchain mining examples employed as the blockchain responder component 206.

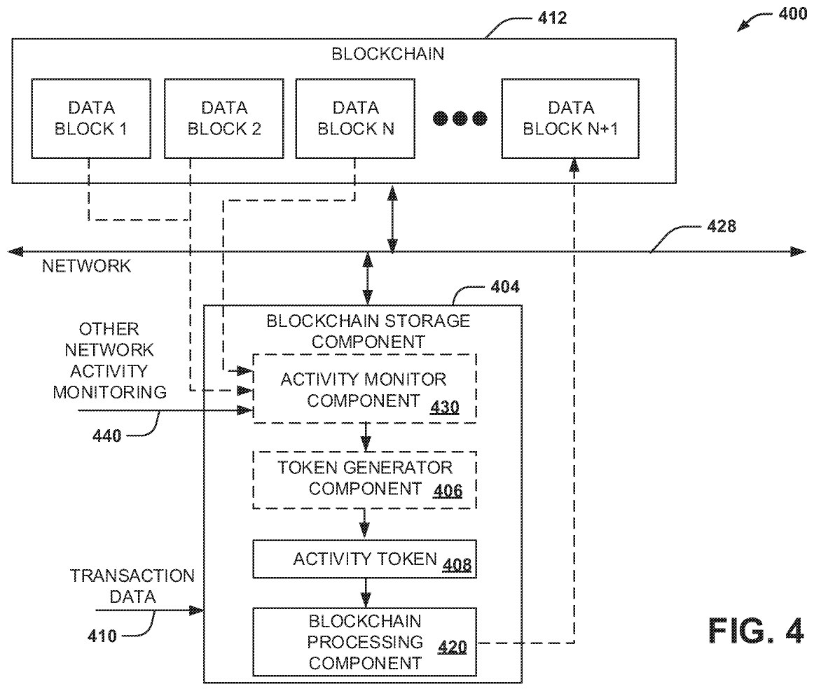

To update the blockchain 208, the validator component 204 can include a validator blockchain storage component 230 that employs an activity token 234 that is used by a blockchain processing component 238 to perform cryptographic operations to store transaction data in the blockchain 208 as described herein. In another example, the blockchain responder component 206 can include a responder blockchain storage component 240 that employs an activity token 244 that is used by a blockchain processing component 248 to perform cryptographic operations to store transaction data in the blockchain 208 as described herein. In yet other examples, both the validator component 204 and blockchain responder component 206 include respective blockchain storage components 230 and 240. Further description of how activity tokens are generated and processed are provided with respect to FIGS. 4-8.

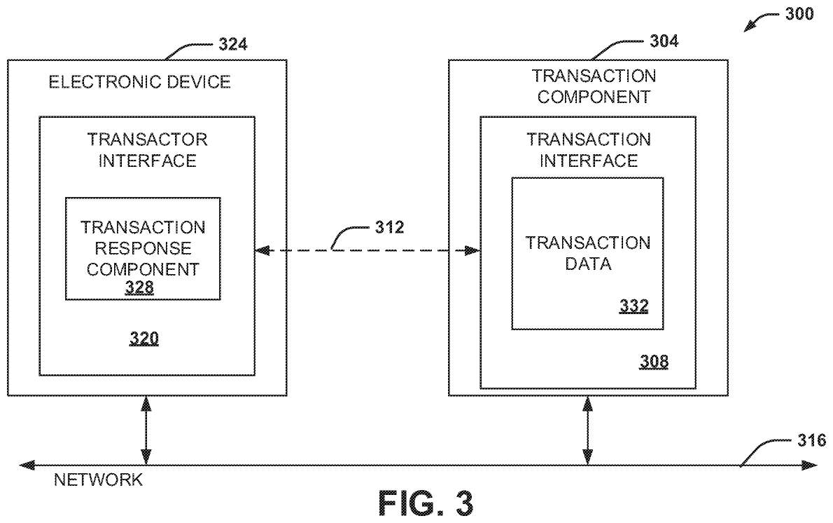

FIG. 3 illustrates an example, non-limiting network system 300 that includes a transaction component 304 operated by at least one validator component (not shown) to facilitate validating and storing transaction data in a blockchain in accordance with one or more examples described herein. The transaction component 304 includes a transaction interface 308 that operates via a network connection 312 across network 316. The network connection 312 connects to a transactor interface 320 operated on an electronic device 324 that can include a computer, cell phone, workstation, personal digital assistant, or substantially any suitable device capable of operating the transactor interface. A transaction response component 328 is provided to enable answering authentication and/or security questions regarding the underlying transaction that is issued from the transaction component 304 and as provided by the transaction interface 308. As shown, the transaction interface 308 can issue various types of queries to the transactor interface 320 in which the transactor provides a response thereto via the transaction response component 328.

The transactor interface 320 can be tasked with rendering at least a portion of a security/transaction process (e.g., encrypted query) described herein via a display of the electronic device 324. The rendering can include at least one of rendering visual data associated with the security process via the display and rendering contextual data associated with the transaction via the display. Rendering the visual data can include at least one of presenting the visual data associated with a query regarding information contained in the portion of the transaction data and generating a query regarding contextual information for the transaction. As mentioned previously, rendering the visual data can include at least one of presenting the visual data based on a timestamp associated with the transaction and rendering the visual data by executing an automated Turing test associated with the challenge-response authentication of the system.

FIG. 4 illustrates an example non-limiting network system 400 that includes a blockchain storage component 404 operating in accordance with a token generator component 406 to generate an activity token 408 to facilitate storing transaction data 410 in a blockchain 412 in accordance with one or more examples described herein. The blockchain storage component 404 to creates a subsequent data block N+1 of the blockchain 412 having N data blocks in response to a storage command, N being a positive integer. As mentioned previously, the activity token 408 represents at least one previous network action of an entity (see e.g., FIG. 2 validator component and/or blockchain responder component) operating the blockchain storage component 404. A blockchain processing component 420 generates the storage command based on cryptographic processing of at least one of the N data blocks of the blockchain 412, the N+1 data block, and the activity token 408. The activity token 408 is employed by the blockchain processing component 404 to reduce the cryptographic processing of the N+1 data block of the blockchain 412. As shown, the blockchain storage component 404 operates over a network 428 to interact with the blockchain 412 and store the transaction data 410 therein.

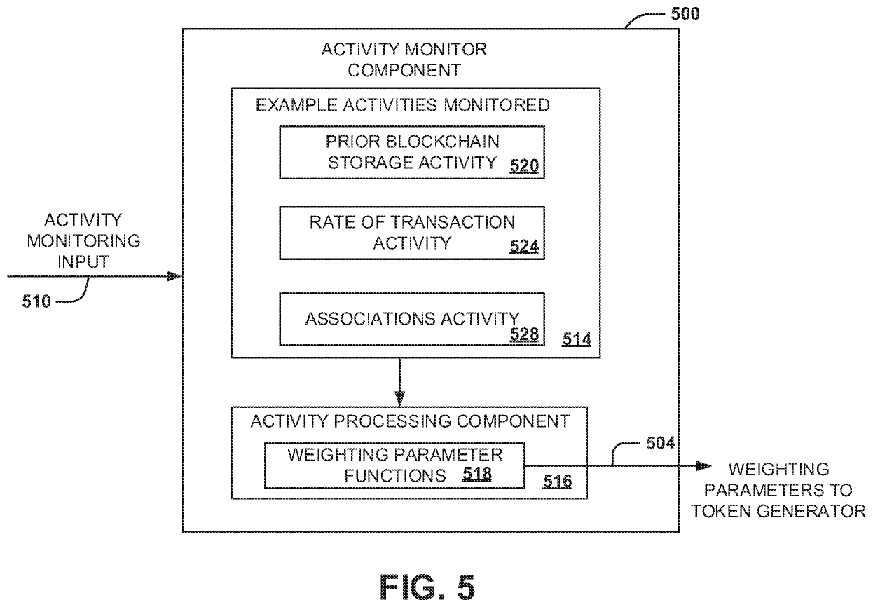

An activity monitor component 430 receives indications (e.g., computer-generated inputs) of previous network activities of the blockchain storage component 404. The network activities can include indications of previous success of the blockchain storage component to have created one or more data blocks in the blockchain 412 in one example. At 440, other network activities related to the blockchain storage component 404 can also be monitored by the activity monitoring component 430. Such activities are described below with respect to the activity monitor component depicted in FIG. 5. The activating monitoring component 430 outputs one or more weighting parameters to the token generator component 406. The weighting parameters reflect the nature (e.g., importance, reliability) of the blockchain storage component's network activities. For example, success in creating a previous data block may be weighted higher than the respective block chain storage component's relationship to a given network of entities (e.g., blockchain responder social network).

Based on the weighting parameters, the token generator 406 generates the activity token 408 which allows the blockchain storage component 404 to employ fewer cryptographic processing actions when creating subsequent data blocks in the blockchain 412. Further description of how the token generator 406 processes the weighting parameters from the activity monitor component 430 is illustrated and described below with respect to FIG. 6. It is noted that the blockchain storage component 404 may include the activity monitor component 430 and/or token generator component 406 to receive the respective activity token 408 during the normal course of its respective storage and processing activities. In other implementation examples, the activity monitor component 430 and/or token generator component 406 may be implemented via a third-party system (not shown) operating on the network 428 which monitors activities of a plurality of respective blockchain storage components. Based on such third-party monitoring and/or token generation, the activity tokens 408 are received by the blockchain storage component 404 from the third-party systems over the network 428.

FIG. 5 illustrates an example of an activity monitor component 500 to monitor blockchain activities and to apply weighting parameters 504 to the activities to facilitate storing transaction data in a blockchain in accordance with one or more examples described herein. The activity monitor component 500 receives activity monitoring input 510 which can include substantially any network activity. Example network activities monitored and received as input 510 are illustrated at 514. The activity monitor component 500 records (e.g., stores) activity data relating to the network activities of the blockchain storage component described previously and assigns the weighting parameters 504 to the activity data associated with each of the respective network activities. An activity processing component 516 receives the activity data 514 and employs one or more weighting parameter functions 518 to assign the weighting parameters to the respective network activities monitored by the activity monitoring component 500 and represented as the activity data 514. The weighting parameter functions can be numerical output generators in one example that assign numerical weights and tags indicating what the weights are related to according to the number of previous data blocks created, rate transactions described below, the number of detected network associations between network entities, and so forth.

As shown at 520, the activity data can include at least one of prior blockchain storage activity data for the blockchain storage component. This data can include an indication of previous success in the actual creation of a given data block in the blockchain. At 524, a rate of transaction data for the blockchain storage component can be stored, and at 528, associations activity data relating to prior interactions of the blockchain storage component and other network components. The rate of transaction data 524 is related to at least one of quantity of interactions the blockchain storage component has with other network components, types of interactions the blockchain storage component has with other network components, time of interactions the blockchain storage component has with other network components, and influence of the blockchain storage component has with respect to other network components.

The activity tokens described herein can be used in one example by blockchain storage components as a proof of reputation to mitigate blockchain processing of future data blocks through networks and regarding how the respective components interact with such networks. For example, social network scores can be generated (or determined) that reflects the engagement of the storage components (or entities associated therewith) to the networks. Thus, the activity token or reputation score can be included with transaction information to incentivizes storage components beyond a reward since future blockchain processing is reduced. Therefore, since blockchain processing proceeds in a forward direction, if various processing/network events are tagged to a reputation score (or token) that perpetuates in the respective data blocks, and added as a weighting parameter, then validators (or other entities) can vouch for given storage components that satisfy these parameters.

As a blockchain responder for example, several storage components with different reputation scores, one responder could potentially have to perform more processing work than a lower reputation responder, which may thus represent a riskier transaction. Reputation scores for example, can include rate of transactions (e.g., how active the responder has been within the community activities, longevity, influence, and so forth). This can include associations with higher reputation users (e.g., those responders who have had success updating the blockchain in the past). Also, reputation tokens (e.g., activity tokens) could be sent to an address within the network. Respective tokens can be traded or sold and can be associated with unique identifiers with associated metadata to provide reputation information related to the blockchain storage component and/or entity operating the storage component.

FIG. 6 illustrates an example token generator component 600 that receives weighting parameters 604 to generate an activity token 610 to facilitate storing transaction data in a blockchain in accordance with one or more examples described herein. The token generator 600 processes the weighting parameters 604 received from the activity monitor component illustrated and described above with respect to FIG. 6. The token generator component 600 includes a weighting parameter processing component 620 to generate a weighting score 624 that assigns a relative value to the weighting parameters 604. For instance, the weighting score 624 may be assigned a higher score value based on weighting parameters 604 tagged to previous block chain storage success versus other network activity (e.g., social network activity or relationships to other network users).

The weighting score 628 can be compared to a threshold value by a threshold detector component 628 (e.g., digital comparator) to determine whether to issue the activity token 610 to the blockchain storage component based on the weighting score exceeding the threshold value. The threshold values can be predetermined and/or dynamically generated based on evolving standards of network activity. When the activity token 610 has been generated, a token transmitter component 632 (e.g., network adapter) can transmit the activity token to be used by the blockchain storage component.

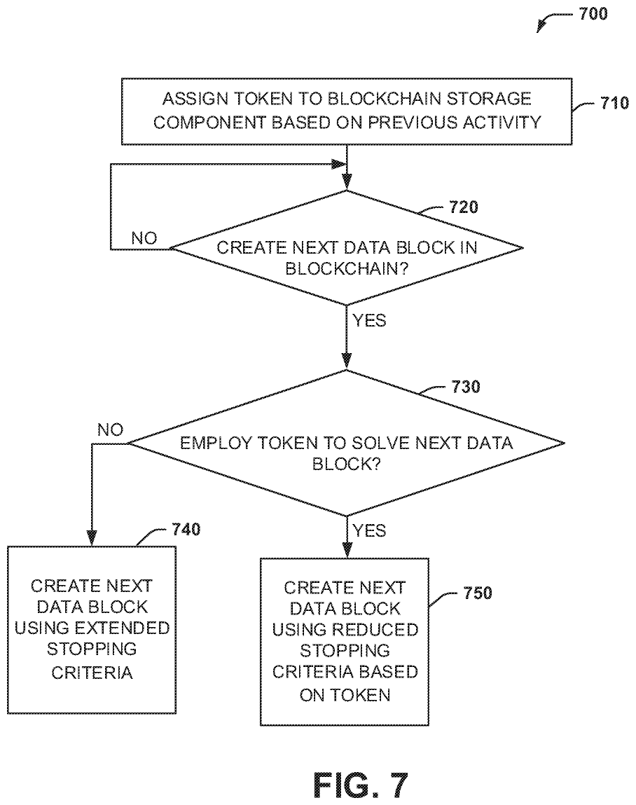

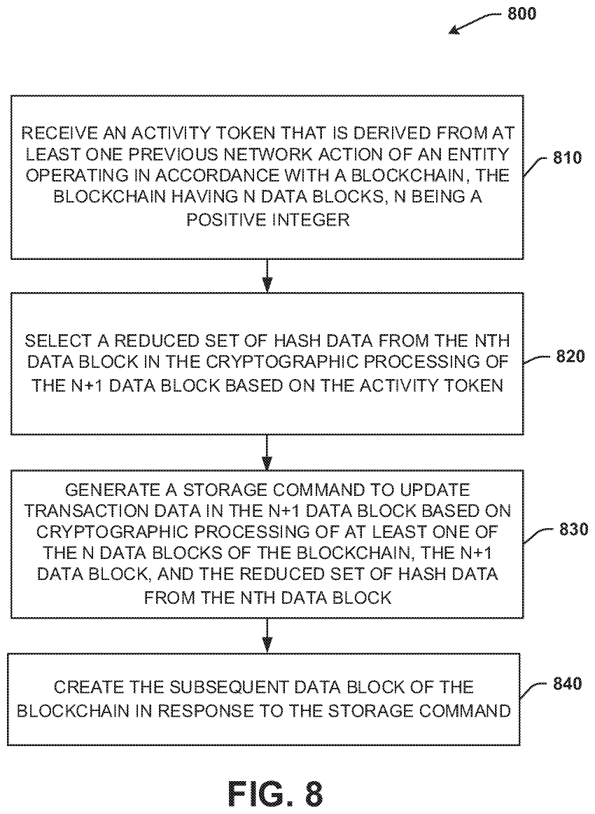

FIGS. 7 and 8 illustrate computer-implemented methodologies via flow diagrams in accordance with the disclosed subject matter. For simplicity of explanation, the methodologies are depicted and described as a series of acts. It is to be understood and appreciated that the subject methods are not limited by the acts illustrated and/or by the order of acts, for example acts can occur in various orders and/or concurrently, and with other acts not presented and described herein. Furthermore, not all illustrated acts may be employed to implement the respective methodologies in accordance with the disclosed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any suitable computer/machine-readable device and/or storage media.

FIG. 7 illustrates an example method 700 executed by a system and processor that employs an activity token to facilitate storing transaction data in a blockchain in accordance with one or more examples described herein. Before proceeding, a brief description of current cryptographic processing for blockchains is provided to illustrate the increased processing employed by such systems and how the method 700 advantageously overcomes such limitations. According to standard transaction processing, transactors create a set of transactions. Blockchain responders (e.g., miners) accumulate the transactions to create a data block. A respective blockchain responder executes a Hash of all the transactions together (e.g., referred to as H(T)). Blockchain responders continue to search for some Nonce value that satisfies the following example criteria: H(H(T), Nonce) begins with 10 binary 0's. In SHA256, this would imply that the other 246 bits are some random number. The following method 700 illustrates how such cryptographic hash processing is reduced as has been previously mentioned herein.

At 710, after creating their first block, the blockchain responder can be assigned a token (e.g., activity token) which references their processing efforts having created a data block at some point in the past. For instance, the respective token can enable the blockchain responder with an extra stopping criteria solution (e.g., to reduce processing in the creation of subsequent data block) which is related to the data block they had previously solved.

At 720, a determination is made as to whether to create another data block in the blockchain. If not, the method proceeds back to 720. If the next data block is to be created at 720, the method proceeds to 730. When attempting to create the subsequent data block in the blockchain, the blockchain responder can decide at 730 whether to use conventional processing that utilizes more cryptographic processing as described above or whether to employ the token as described herein for the processing and storage of the subsequent data block. If the token is not employed at 730, the process proceeds to 740 and utilizes extended stopping criteria to create the next data block. At 740, the blockchain responder component could then solve for the original stopping criteria solution where: H(H(T2), Nonce) begins with 10 binary 0's, for example. If a token is detected at 730, the block chain responder component can proceed to 750 now solve for H(H(T2), Nonce) begins with the binary digits that came after the first 10 0's in the previous data block 1 in this example. In other words, the subsequent data block can discard the 10 (or other number) of leading 0's that were solved for the previous block in the computation of the subsequent data block. The following describes an example of such computations:

Block 1 Hash Example: 000000000010101010001

Block 2 Hash can begin with 0000000000 (if conventional processing employed) or based on enablement by the token, can ignore the 10 leading zeros of this example sequence and proceed with processing fewer digits in the sequence beginning with the example sequence 10101010. This increases the probability that the blockchain responder now can solve the subsequent data block with a 5/1024 probability instead of 1/1024 if all binary digits were employed in the computation as in current systems that do not employ token processing. In some examples, the activity token can be traded (e.g., straight-forward transaction flow) between parties and also phased out over time simply by making the stopping criteria described herein utilize more binary digits from the original hash data.

FIG. 8 illustrates an example non-limiting method 800 executed by a system and processor that employs an activity token to mitigate hash processing of a data block to facilitate storing transaction data in a blockchain in accordance with one or more examples described herein. At 810, method 800 includes receiving, by a system having a processor and a memory, an activity token that is derived from at least one previous network action of an entity operating in accordance with a blockchain, the blockchain having N data blocks, N being a positive integer (e.g., received via block chain storage component 104 of FIG. 1).

At 820, method 800 includes selecting, by the system, a reduced set of hash data from the Nth data block in the cryptographic processing of a subsequent data block N+1 based on the activity token (e.g., via blockchain processing component 130 of FIG. 1). At 830, the method 800 includes generating, by the system, a storage command to update transaction data in the N+1 data block based on cryptographic processing of at least one of the N data blocks of the blockchain, the N+1 data block, and the reduced set of hash data from the Nth data block (e.g., via blockchain processing component 130 of FIG. 1). At 840, the method 800 includes creating, by the system, the subsequent data block of the blockchain in response to the storage command (e.g., via blockchain storage component 104 of FIG. 1).

Although not shown, the method 800 can also include solving, by the system, a cryptographic hash function represented as H(H(N+1), Nonce), that removes at least one binary digit from a previous hash function applied to the Nth data block, where H is a hash operation, H(N+1) is a hash function applied to the N+1 data block of the blockchain, and the Nonce is an arbitrary number that is used singularly in a cryptographic process. As mentioned previously, the activity token can be expressed as a numerical value, a mathematical function, or a probability value that indicates a reliability to create the subsequent data block in the blockchain based on previous network activities.

The method 800 can also include recording, by the system, activity data relating to the network activities of storing data to the blockchain. This can include assigning a weighting parameter to the activity data associated with each of the respective network activities. The activity data, for example, can include at least one of prior blockchain storage activity data, a rate of transaction data, and associations activity data relating to other network components. The method 800 can also include processing the weighting parameters received from the activity monitor and generating a weighting score that assigns a relative value to the weighting parameters. In another example, the method 800 can include comparing the weighting score to a threshold value to determine whether to issue the activity token.

FIG. 9 illustrates an example non-limiting network system 900 that includes a blockchain storage component 904 and a blockchain processing component 906 to facilitate storing transaction data 908 in a blockchain (not shown) in accordance with one or more examples described herein. The system 900 includes a memory 910 and a processor 914 configured to execute computer instructions stored in the memory that when executed cause the system to perform operations as described herein. The computer instructions include the blockchain storage component 904 to create a subsequent data block N+1 of a blockchain having N data blocks in response to a storage command, N being a positive integer. An activity token 920 represents at least one previous network action of an entity (e.g., validator component and/or blockchain responder component) operating the blockchain storage component 904. The blockchain processing component 906 generates the storage command based on cryptographic processing of at least one of the N data blocks of the blockchain, the N+1 data block, and the activity token 920. The activity token is employed by the blockchain processing component 906 to reduce the cryptographic processing of the N+1 data block. As shown at 924, transaction data is exchanged between the network system 900 with a blockchain that can be stored across in across one or more network assets associated with the blockchain.

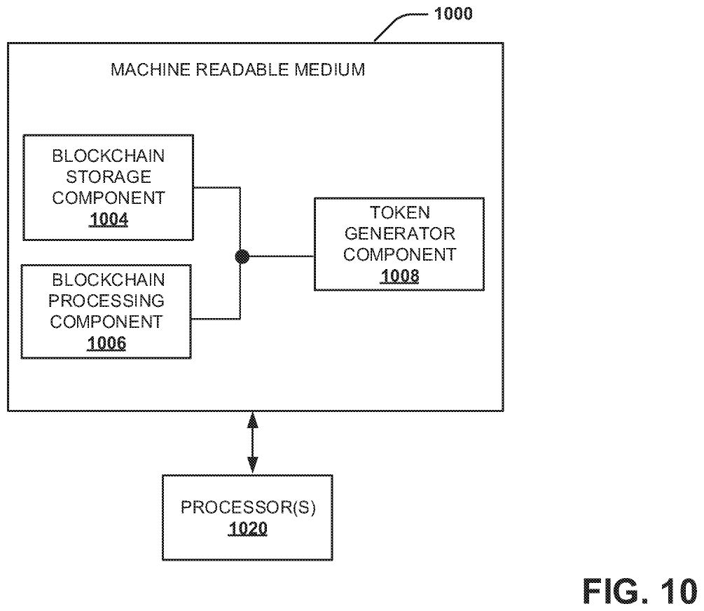

FIG. 10 illustrates an example of a non-limiting machine-readable medium 1000 that includes a blockchain storage component 1004 to store transaction data in a blockchain (not shown), a blockchain processing component 1006 to process transaction data and activity tokens as described herein, and a token generator component 1008 to generate activity tokens in accordance with one or more examples described herein. The machine-readable medium 1000 includes machine-readable instructions that when executed by a processor 1020 cause the processor to generate an activity token that is derived from at least one previous network action of an entity operating in accordance with a blockchain, the blockchain having N data blocks, N being a positive integer.

The instructions select a reduced set of hash data from the Nth data block in the cryptographic processing of a subsequent data block N+1 based on the activity token. The instructions generate a storage command to update transaction data in the N+1 data block based on cryptographic processing of at least one of the N data blocks of the blockchain, the N+1 data block, and the reduced set of hash data from the Nth data block. The instructions store the transaction data in the subsequent data block of the blockchain in response to the storage command. The instructions can further cause the processor 1020 to solve a cryptographic hash function represented as H(H(N+1), Nonce), that removes at least one binary digit from a previous hash function applied to the Nth data block, where H is a hash operation, H(N+1) is a hash function applied to the N+1 data block of the blockchain, and the Nonce is an arbitrary number that is used singularly in a cryptographic process.

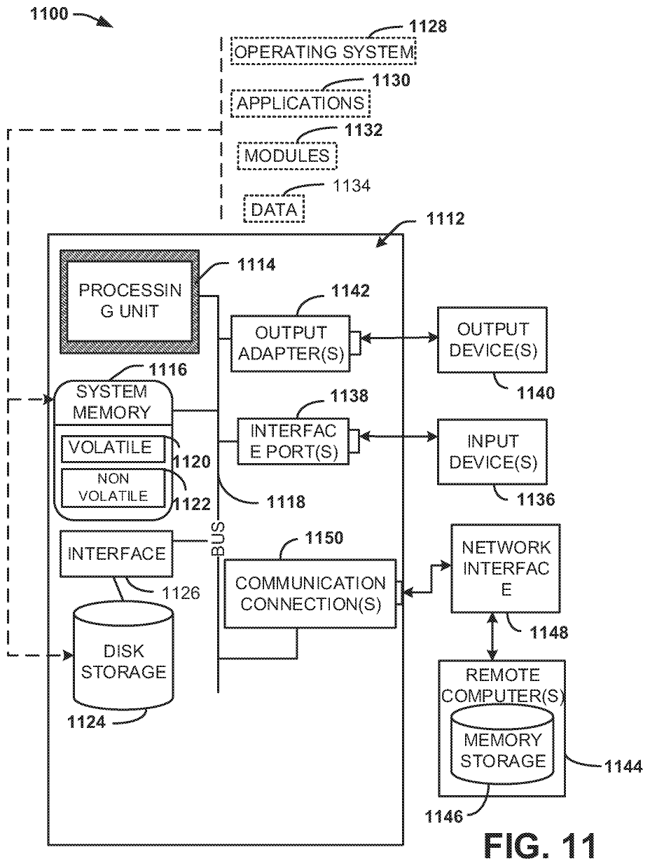

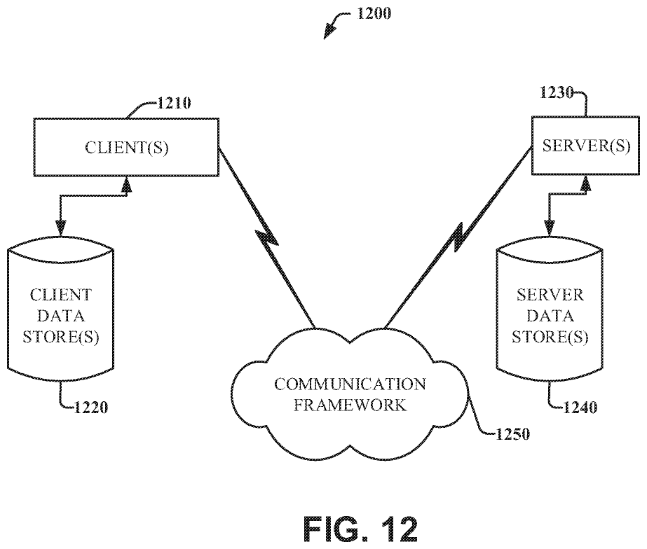

In order to provide a context for the various examples of the disclosed subject matter, FIGS. 11 and 12 as well as the following discussion are intended to provide a brief, general description of a suitable environment in which the various examples of the disclosed subject matter may be implemented.

FIG. 11 is a schematic block diagram illustrating a suitable operating environment example to facilitate storing transaction data in a blockchain in accordance with one or more examples described herein. With reference to FIG. 11, a suitable environment 1100 for implementing various aspects of this disclosure includes a computer 1112. The computer 1112 includes a processing unit 1114, a system memory 1116, and a system bus 1118. The system bus 1118 couples system components including, but not limited to, the system memory 1116 to the processing unit 1114. The processing unit 1114 can be any of various available suitable processors. Dual microprocessors and other multiprocessor architectures also can be employed as the processing unit 1114.

The system bus 1118 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1116 includes volatile memory 1120 and nonvolatile memory 1122. The basic input/output system (BIOS), containing the basic routines to transfer information between elements within the computer 1112, such as during start-up, is stored in nonvolatile memory 1122. By way of illustration, and not limitation, nonvolatile memory 1122 can include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM). Volatile memory 1120 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 1112 also includes removable/non-removable, volatile/non-volatile computer storage media. FIG. 11 illustrates, for example, a disk storage 1124. Disk storage 1124 includes, but is not limited to, devices like a magnetic disk drive, floppy disk drive, tape drive, Jaz drive, Zip drive, LS-100 drive, flash memory card, or memory stick. The disk storage 1124 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1124 to the system bus 1118, a removable or non-removable interface is typically used, such as interface 1126.

FIG. 11 also depicts software that acts as an intermediary between users and the basic computer resources described in the suitable operating environment 1100. Such software includes, for example, an operating system 1128. Operating system 1128, which can be stored on disk storage 1124, acts to control and allocate resources of the computer system 1112. System applications 1130 take advantage of the management of resources by operating system 1128 through program modules 1132 and program data 1134, e.g., stored either in system memory 1116 or on disk storage 1124. It is to be appreciated that this disclosure can be implemented with various operating systems or combinations of operating systems.

A user enters commands or information into the computer 1112 through input device(s) 1136. Input devices 1136 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1114 through the system bus 1118 via interface port(s) 1138. Interface port(s) 1138 include, for example, a serial port, a parallel port, a game port, and a universal serial bus (USB). Output device(s) 1140 use some of the same type of ports as input device(s) 1136. Thus, for example, a USB port may be used to provide input to computer 1112, and to output information from computer 1112 to an output device 1140. Output adapter 1142 is provided to illustrate that there are some output devices 1140 like monitors, speakers, and printers, among other output devices 1140, which require special adapters. The output adapters 1142 include, by way of illustration and not limitation, video and sound cards that provide a means of connection between the output device 1140 and the system bus 1118. It should be noted that other devices and/or systems of devices provide both input and output capabilities such as remote computer(s) 1144.

Computer 1112 can operate in a networked environment using logical connections to one or more remote computers, such as remote computer(s) 1144. The remote computer(s) 1144 can be a personal computer, a server, a router, a network PC, a workstation, a microprocessor-based appliance, a peer device or other common network node and the like, and typically includes many or all of the elements described relative to computer 1112. For purposes of brevity, only a memory storage device 1146 is illustrated with remote computer(s) 1144. Remote computer(s) 1144 is logically connected to computer 1112 through a network interface 1148 and then physically connected via communication connection 1150. Network interface 1148 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1150 refers to the hardware/software employed to connect the network interface 1148 to the bus 1118. While communication connection 1150 is shown for illustrative clarity inside computer 1112, it can also be external to computer 1112. The hardware/software necessary for connection to the network interface 1148 includes, for exemplary purposes only, internal and external technologies such as, modems including regular telephone grade modems, cable modems and DSL modems, ISDN adapters, and Ethernet cards.

FIG. 12 is a schematic block diagram of an example-computing environment to facilitate storing transactions in a blockchain in accordance with one or more examples described herein. FIG. 12 is a schematic block diagram of a sample-computing environment 1200 with which the subject matter of this disclosure can interact. The system 1200 includes one or more client(s) 1210. The client(s) 1210 can be hardware and/or software (e.g., threads, processes, computing devices). The system 1200 also includes one or more server(s) 1230. Thus, system 1200 can correspond to a two-tier client server model or a multi-tier model (e.g., client, middle tier server, data server), amongst other models. The server(s) 1230 can also be hardware and/or software (e.g., threads, processes, computing devices). The servers 1230 can house threads to perform transformations by employing this disclosure, for example. One possible communication between a client 1210 and a server 1230 may be in the form of a data packet transmitted between two or more computer processes.

The system 1200 includes a communication framework 1250 that can be employed to facilitate communications between the client(s) 1210 and the server(s) 1230. The client(s) 1210 are operatively connected to one or more client data store(s) 1220 that can be employed to store information local to the client(s) 1210. Similarly, the server(s) 1230 are operatively connected to one or more server data store(s) 1240 that can be employed to store information local to the servers 1230.

The above systems and methods described with respect to FIGS. 1-12 can be employed to facilitate transactions in accordance with a transaction system and in accordance with one or more examples described herein. The respective systems can be implemented on or in connection with a network of servers associated with an enterprise application, for example. In one example, the system can be associated with a cloud-based platform and can also be associated with a computing environment that comprises one or more servers and/or one or more software components that operate to perform one or more processes, one or more functions and/or one or more methodologies in accordance with the described examples. A sever as disclosed herein can include, for example, stand-alone server and/or an enterprise-class server operating a server operating system (OS) such as a MICROSOFT® OS, a UNIX® OS, a LINUX® OS, and/or another suitable server-based OS. It is to be appreciated that one or more operations performed by a server and/or one or more services provided by a server can be combined, distributed, and/or separated for a given implementation. Furthermore, one or more servers can be operated and/or maintained by a corresponding entity or different entities.

The system can be employed by various systems, such as, but not limited to transaction systems, payment systems, online transaction systems, online payment systems, server systems, electronic device systems, mobile device systems, smartphone systems, virtual machine systems, consumer service systems, mobile application systems, financial systems, digital systems, machine learning systems, artificial intelligence systems, neural network systems, network systems, computer network systems, communication systems, enterprise systems, asset management systems, cloud storage systems, social networking systems, point of sale (POS) systems, and the like (note that the terms used above as examples are not mutually exclusive; a “transaction system” does not imply that system cannot also include or be a payment system, server system, and so forth).

In one example, the systems described herein can be associated with a Platform-as-a-Service (PaaS). Moreover, the system and/or the components of the system can be employed to use hardware and/or software to solve problems that are technical in nature (e.g., related to a computing system, related to a server system, related to digital data processing, and so forth), that are not abstract and that cannot be performed as a set of mental acts by a human.

Systems and components can be implemented as stored software instructions that are executable by a processor to cause various operations to occur. Aspects of the systems, apparatuses or processes described herein can constitute machine-executable component(s) embodied within machine(s), e.g., embodied in one or more computer readable mediums (or media) associated with one or more machines. Such component(s), when executed by the one or more machines, e.g., computer(s), computing device(s), virtual machine(s), and so forth, can cause the machine(s) to perform the operations described. The systems can include memory for storing computer executable components and instructions. The systems can further include a processor (or processors) to facilitate operation of the instructions (e.g., computer executable components and instructions).

The transactions described herein can be an electronic exchange executed by an electronic device. Furthermore, the transaction can be associated with one or more events (e.g., one or more transaction events) associated with the electronic device. In an example, an event associated with the transaction can include a numerical value corresponding to an amount for a transaction. Additionally or alternatively, an event associated with the transaction can include time data related to a timestamp for the transaction. An event associated with the transaction can additionally or alternatively include an item associated with the transaction and/or an identifier for one or more entities associated with the transaction. In some examples, the transaction can include a set of transaction requests for an online transaction system. In some examples, the transaction can be a financial transaction. For example, the transaction can be data to facilitate a transfer of funds for transactions between two entities.

In some examples, the transaction can be associated with a web request session. For instance, the web request session can include, for example, establishing a connection with a transaction system (e.g., an online transaction system), sending one or more requests to the transaction system (e.g., an online transaction system) for web session content, and/or receiving web session content from the transaction system (e.g., an online transaction system). In an aspect, the transaction can result in one or more actions, one or more tasks, one or more processes, one or more requests, and/or one or more transmissions being performed via the electronic device and/or an online transaction system in communication with the electronic device.

The electronic device described herein can be a computing device, a user device, a client device, a mobile device, a smart phone, a tablet device, a handheld device, a portable computing device, a smart device (e.g. an Internet-of-Things devices such as a smart television, and so forth), a wearable device, a computer, a desktop computer, a laptop computer, a point of sale (POS) device, and/or another type of electronic device associated with a display (e.g., the electronic device can be more than one of the type of devices listed above, which are non-exclusive categories in various embodiments). In an example, the interfaces described herein can render one or more graphical elements associated with the transactions described herein and presented on a display of the electronic device. This can include management of one or more communications and/or one or more transmissions with respect to the electronic device to facilitate the transaction via the electronic device.

The transaction systems described herein can be an online transaction system in an example and the electronic devices described herein can be in communication via a network. The network can be a communication network, a wireless network, an IP network, a voice over IP network, an internet telephony network, a mobile telecommunications network, a landline telephone network, a personal area network, a wired network, and/or another type of network. The online transaction system can be, for example, a stand-alone server and/or an enterprise-class server operating a server OS such as a MICROSOFT® OS, a UNIX® OS, a LINUX® OS, and/or another suitable server-based OS. It is to be appreciated that one or more operations performed by the online transaction system and/or one or more services provided by the online transaction system can be combined, distributed, and/or separated for a given implementation example. Furthermore, the online transaction system can be associated with a payment system, an online payment system, an enterprise system, and/or another type of system.

Electronic accounts can be managed by the online transaction system. Furthermore, the electronic device can access data regarding the electronic account via the online transaction system, for example. In some examples, the electronic account can facilitate online payments and/or can provide access to funds. In an example, the electronic account can be associated with one or more transactions. For instance, one or more transactions can be executed and/or initiated via the electronic device. The electronic account and/or the electronic device can be associated with a user (e.g., a user identity, a buyer, a seller, and so forth). In an example, a transaction for the electronic account can be executed by the online transaction system. Additionally or alternatively, a payment related to the transaction for the electronic account can be processed by the online transaction system. In another example, data associated with the electronic account can be rendered via a display of the electronic device. For instance, data associated with the electronic account can be rendered as one or more visual elements via a display of the electronic device.

It is to be noted that aspects or features of this disclosure can be exploited in substantially any wireless telecommunication or radio technology, e.g., Wi-Fi; Bluetooth; Worldwide Interoperability for Microwave Access (WiMAX); Enhanced General Packet Radio Service (Enhanced GPRS); Third Generation Partnership Project (3GPP) Long Term Evolution (LTE); Third Generation Partnership Project 2 (3GPP2) Ultra Mobile Broadband (UMB); 3GPP Universal Mobile Telecommunication System (UMTS); High Speed Packet Access (HSPA); High Speed Downlink Packet Access (HSDPA); High Speed Uplink Packet Access (HSUPA); GSM (Global System for Mobile Communications) EDGE (Enhanced Data Rates for GSM Evolution) Radio Access Network (GERAN); UMTS Terrestrial Radio Access Network (UTRAN); LTE Advanced (LTE-A); etc. Additionally, some or all of the examples described herein can be exploited in legacy telecommunication technologies, e.g., GSM. In addition, mobile as well non-mobile networks (e.g., the Internet, data service network such as internet protocol television (IPTV), etc.) can exploit aspects or features described herein.

While the subject matter has been described above in the general context of computer-executable instructions of a computer program that runs on a computer and/or computers, those skilled in the art will recognize that this disclosure also can or may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., PDA, phone), microprocessor-based or programmable consumer or industrial electronics, and the like. The illustrated aspects may also be practiced in distributed computing environments where tasks are performed by remote processing devices that are linked through a communications network. However, some, if not all aspects of this disclosure can be practiced on stand-alone computers. In a distributed computing environment, program modules may be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

In another example, respective components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

Various aspects or features described herein can be implemented as a method, apparatus, system, or article of manufacture using standard programming or engineering techniques. In addition, various aspects or features disclosed in this disclosure can be realized through program modules that implement at least one or more of the methods disclosed herein, the program modules being stored in a memory and executed by at least a processor. Other combinations of hardware and software or hardware and firmware can enable or implement aspects described herein, including a disclosed method(s). The term “article of manufacture” as used herein can encompass a computer program accessible from any computer-readable device, carrier, or storage media. For example, computer readable storage media can include but are not limited to magnetic storage devices (e.g., hard disk, floppy disk, magnetic strips . . . ), optical discs (e.g., compact disc (CD), digital versatile disc (DVD), blu-ray disc (BD) . . . ), smart cards, and flash memory devices (e.g., card, stick, key drive . . . ), or the like.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor may also be implemented as a combination of computing processing units.

In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or methods herein are intended to include, without being limited to including, these and any other suitable types of memory.

It is to be appreciated and understood that components, as described with regard to a particular system or method, can include the same or similar functionality as respective components (e.g., respectively named components or similarly named components) as described with regard to other systems or methods disclosed herein.

What has been described above includes examples of systems and methods that provide advantages of this disclosure. It is, of course, not possible to describe every conceivable combination of components or methods for purposes of describing this disclosure, but one of ordinary skill in the art may recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A system, comprising:
a memory; and
a processor configured to execute computer instructions stored in the memory that when executed cause the system to perform operations, the computer instructions further comprising:
a blockchain storage component to create a subsequent data block N+1 of a blockchain having N data blocks in response to a storage command, N being a positive integer;
an activity token that represents at least one previous network action of an entity operating the blockchain storage component; and
a blockchain processing component to generate the storage command based on cryptographic processing of at least one of the N data blocks of the blockchain, the N+1 data block, and the activity token, wherein the activity token is employed by the blockchain processing component to reduce the cryptographic processing of the N+1 data block.

2. The system of claim 1, wherein the activity token enables the blockchain processing component to select a reduced set of hash data from the Nth data block in the cryptographic processing of the N+1 data block.

3. The system of claim 2, wherein the activity token enables the blockchain processing component to solve a cryptographic hash function represented as H(H(N+1), Nonce) that removes at least one binary digit from a previous hash function applied to the Nth data block, where H is a hash operation, H(N+1) is a hash function applied to the N+1 data block of the blockchain, and the Nonce is an arbitrary number that is used singularly in a cryptographic process.

4. The system of claim 1, wherein the activity token is expressed as a numerical value, a mathematical function, or a probability value that indicates reliability of the blockchain storage component to create the subsequent data block in the blockchain based on previous network activities.

5. The system of claim 4, further comprising an activity monitor component to record activity data relating to the network activities of the blockchain storage component, and to assign a weighting parameter to the activity data associated with each of the respective network activities.

6. The system of claim 5, wherein the activity data can include at least one of prior blockchain storage activity data for the blockchain storage component, a rate of transaction data for the blockchain storage component, and associations activity data relating to prior interactions of the blockchain storage component and other network components.

7. The system of claim 6, wherein the rate of transaction data is related to at least one of quantity of interactions the blockchain storage component has with other network components, types of interactions the blockchain storage component has with other network components, time of interactions the blockchain storage component has with other network components, and influence of the blockchain storage component has with respect to other network components.

8. The system of claim 5, further comprising a token generator component to process the weighting parameters received from the activity monitor component and to generate a weighting score that assigns a relative value to the weighting parameters, wherein the weighting score is compared to a threshold value to determine whether to issue the activity token to the blockchain storage component.

9. The system of claim 1, further comprising at least one of a validator component to facilitate a transaction with a transactor for transaction data, and a blockchain responder component entrusted to update the blockchain, wherein at least one of the validator component and the blockchain responder component executes the blockchain storage component to store the transaction data in the blockchain.

10. The system of claim 9, wherein the validator component operates with a transaction component to form a transaction system to facilitate collecting the transaction data from the transactor.

11. The system of claim 10, wherein the at least one transaction component includes a transaction interface to interact with the transactor to facilitate performing at least one of a financial exchange between parties, a file exchange between parties, and a property exchange between parties, wherein the N+1 data block in the blockchain is employed to record the exchanges.

12. A computer-implemented method, comprising:
receiving, by a system having a processor and a memory, an activity token that is derived from at least one previous network action of an entity operating in accordance with a blockchain, the blockchain having N data blocks, N being a positive integer;
selecting, by the system, a reduced set of hash data from the Nth data block in the cryptographic processing of a subsequent data block N+1 based on the activity token;
generating, by the system, a storage command to update transaction data in the N+1 data block based on cryptographic processing of at least one of the N data blocks of the blockchain, the N+1 data block, and the reduced set of hash data from the Nth data block; and
creating, by the system, the subsequent data block of the blockchain in response to the storage command.

13. The computer-implemented method of claim 12, further comprising solving, by the system, a cryptographic hash function represented as H(H(N+1), Nonce), that removes at least one binary digit from a previous hash function applied to the Nth data block, where H is a hash operation, H(N+1) is a hash function applied to the N+1 data block of the blockchain, and the Nonce is an arbitrary number that is used singularly in a cryptographic process.

14. The computer-implemented method of claim 12, wherein the activity token is expressed as a numerical value, a mathematical function, or a probability value that indicates a reliability to create the subsequent data block in the blockchain based on previous network activities.

15. The computer-implemented method of claim 14, further comprising:
recording, by the system, activity data relating to the network activities of storing data to the blockchain; and
assigning a weighting parameter to the activity data associated with each of the respective network activities.

16. The computer-implemented method of claim 15, wherein the activity data can include at least one of prior blockchain storage activity data, a rate of transaction data, and associations activity data relating to other network components.

17. The computer-implemented method of claim 15, further comprising:
processing the weighting parameters received from the activity monitor; and
generating a weighting score that assigns a relative value to the weighting parameters.

18. The computer-implemented method of claim 17, further comprising comparing the weighting score to a threshold value to determine whether to issue the activity token.

19. A non-transitory machine-readable medium having machine-readable instructions that when executed by a processor cause the processor to:
generate an activity token that is derived from at least one previous network action of an entity operating in accordance with a blockchain, the blockchain having N data blocks, N being a positive integer;
select a reduced set of hash data from the Nth data block in the cryptographic processing of a subsequent data block N+1 based on the activity token;
generate a storage command to update transaction data in the N+1 data block based on cryptographic processing of at least one of the N data blocks of the blockchain, the N+1 data block, and the reduced set of hash data from the Nth data block; and
store the transaction data in the subsequent data block of the blockchain in response to the storage command.

20. The non-transitory machine-readable medium of claim 19, the instructions further causing the processor to solve a cryptographic hash function represented as H(H(N+1), Nonce), that removes at least one binary digit from a previous hash function applied to the Nth data block, where H is a hash operation, H(N+1) is a hash function applied to the N+1 data block of the blockchain, and the Nonce is an arbitrary number that is used singularly in a cryptographic process.
